(19) United States
(12) Patent Application Publication
(10) Pub. No.: US 2021/0049948 A1
(43) Pub. Date: Feb. 18, 2021

(54) PIXEL LAYER STRUCTURE AND DISPLAY PANEL

(71) Applicant: HKC CORPORATION LIMITED, Shenzhen, Guangdong (CN)

(72) Inventor: Jianfeng SHAN, Shenzhen, Guangdong (CN)

(21) Appl. No.: 17/043,738

(22) PCT Filed: Sep. 12, 2018
(86) PCT No.: PCT/CN2018/105125

§ 371 Date: Sep. 30, 2020

(30) Foreign Application Priority Data
Jul. 17, 2018 (CN) 201810786437.0

(51) Int. Cl. G09G 3/20

(52) U.S. Cl. CPC G09G 3/2003; G09G 2300/0452; G09G 2310/0267; G09G 2310/027; G09G 2330/10

(57) ABSTRACT

Disclosed are a pixel layer structure for display panel and a display panel comprising a plurality of pixels, each of pixels respectively belonging to a first pixels, a second pixels or a third pixel of different color. The pixel layer structure comprises a plurality of pixel layers at the first direction which may be driven by data line arranged vertically. Among the pixels in the pixel layer at the first direction, any two adjacent pixels are two pixels with two different colors among the first pixels, the second pixels and the third pixels. Thereby, the pixel layer and the display panel can eliminate the visual defect of vertical bright lines and vertical dark lines.

### CROSS REFERENCE TO RELATED APPLICATIONS

The present application is the National Stage of International Application with No. PCT/CN2018/105125, filed on Sep. 12, 2018, which claims the benefit of a Chinese patent application filed in the National Intellectual Property Administration, Jul. 17, 2018, with the present application No. 201810786437.0 and title “Pixel layer structure and display panel”, the entire contents of which are hereby incorporated by reference.

### TECHNICAL FIELD

The present application relates to a pixel layer structure and a display panel, and particularly, to a pixel layer structure and a display panel capable of eliminating a visual defect of vertical bright lines and vertical dark lines.

### BACKGROUND

The design of double rate driving (DRD) liquid crystal display is likely to reduce the number of data lines extending and arranged vertically by half, the number of chips for driving data lines, and the usage of print circuit board (PCB), thus greatly lowering the cost. However, the design of double rate driving has an inherent defect, i.e., the occurrence of vertical bright lines and vertical dark lines.

The design of dual rate driving can typically adopt the driving pattern of 2 lines or 1+2 lines. Taking 1+2 lines as example, some of the vertically-arranged pixels driven by the vertical data lines have positive voltage signals while the others have negative voltage signals, and when the positive signal and the negative signal switches over along the signal transmitting direction of scanning line, these pixels are usually at the same column, and their image will become relatively dark. Thus vertical bright lines and vertical dark lines will appear in a gray scale screen.

The vertical bright lines and vertical dark lines of dual rate driving do affect visual quality, and it is one of the technical problems for the skilled in the art that how to avoid vertical bright lines and vertical dark lines while taking the edge of saving data lines and relative components in the dual rate driving technology for a display panel.

### SUMMARY

The present application provides a pixel layer structure and a display panel which is capable of eliminating the visual defect of vertical bright lines and vertical dark lines and reducing the cost of display panel adopting dual rate driving technology.

To have at least one of the advantages or another, an embodiment of the present application provides a pixel layer for a display panel adopting double rate driving (DRD) technology and comprising a plurality of pixels with each having one color from the colors of a first pixels, a second pixels or a third pixel; for instance, the first pixel may be a red pixel, and the second pixels may be a blue pixel, and the third pixel may be a green pixel; the pixel layer includes a plurality of pixel layers at the first directions and a plurality of second direction pixel layers.

The plurality of pixel layer at the first directions may be arranged in parallel and extend along the first direction (e.g., vertical direction); the pixel layer at the first direction includes a plurality of pixels as a part of the plurality of pixels, any two adjacent pixels of which are two pixels among the first pixels, the second pixels and the third pixels, with two different colors.

The plurality of second direction pixel layers may be arranged in parallel and extend along the second direction (e.g., transverse direction); the second direction pixel layer includes a plurality of pixels as a part of the plurality of pixels; the plurality of pixels of the second direction pixel layer comprise the first pixels, the second pixels and the third pixel.

Further, the plurality of pixel layer at the first directions comprise a pixel layer at the first direction with the dark line and a pixel layer at the first direction of bright line; and while displaying the same gray-scale brightness, the display brightness of the pixel layer at the first direction with the bright line is larger than that of the pixel layer at the first direction with the dark line, and the pixel layer at the first direction with the bright line is close and parallel to the pixel layer at the first direction with the dark line; and the two adjacent pixels of the plurality of pixels of the pixel layer at the first direction with the bright line adjacent to the pixel layer at the first direction with the dark line are two pixels among the first pixels, the second pixels and the third pixels, with two different colors.

The pixel layer at the first direction is driven by a data line arranged vertically in first direction; and the pixels in the pixel layer at the first direction have one kind of signal from positive signal and negative signal; and the pixel layer at the first direction with the dark line is the pixel layer at the first direction switching from the positive signal to the negative signal or switching from the negative signal to the positive signal along the signal transmitting direction of scanning line.

Further, the two adjacent pixels of the plurality of pixels of the pixel layer at the first direction with the dark line may also be two pixels among the first pixels, the second pixels and the third pixels, with two different colors.

Some other embodiment of the present application provides a pixel layer for a display panel which includes a plurality of pixels with each having one color from the colors of a first pixels, a second pixels or a third pixels, comprising a plurality of pixel layers at the first directions.

The plurality of pixel layer at the first directions are vertically arranged in parallel, each of the pixel layer at the first directions includes a plurality of pixels as a part of the plurality of pixels; and the plurality of pixel layer at the first direction comprise a pixel layer at the first direction with the dark line and a pixel layer at the first direction of bright line; and while displaying the same gray-scale brightness, the display brightness of the pixel layer at the first direction with the bright line is larger than that of the pixel layer at the first direction with the dark line, and the pixel layer at the first direction with the bright line is close and parallel to the pixel layer at the first direction with the dark line; and the two adjacent pixels of the plurality of pixels of the pixel layer at the first direction with the bright line adjacent to the pixel layer at the first direction with the dark line are two pixels among the first pixels, the second pixels and the third pixels, with two different colors.

Further, the pixel layer at the first direction is driven by a data line arranged vertically; and the pixels in the pixel layer at the first direction have one kind of signal from positive signal and negative signal; and the pixel layer at the first direction with the dark line is the pixel layer at the first direction switching from the positive signal to the negative signal or switching from the negative signal to the positive signal along the signal transmitting direction of scanning line.

Further, the two adjacent pixels of the plurality of pixels of the pixel layer at the first direction with the dark line may also be two pixels among the first pixels, the second pixels and the third pixels, with two different colors.

Some other embodiment of the present application provides a display panel comprising a color filter and a dual rate driving circuit layer.

The color filter includes a plurality of pixel filters arranged in matrix, each pixel filter having its color from one of the colors of a first pixel filter, a second pixel filter and a third pixel filter.

The dual rate driving circuit layer is arranged in parallel with the color filter, and along the vertically-extending direction of data line are a plurality of data line circuits arranged vertically; each data line circuit includes a plurality of pixel circuit units corresponding to the plurality of pixel filter and also arranged in matrix;

in which, the two adjacent pixel filters of the plurality of pixel filters corresponding to the plurality of pixel circuit units in the data line circuit are two pixel filters among the first pixel filter, the second pixel filter and the third pixel filter, with two different colors.

A part of the plurality of data line circuits is data line circuit with the dark line; and the pixel circuit unit in the data line circuit has one kind of signal of positive signal and negative signal; and the data line circuit with the dark line is a data line circuit switching from the positive signal to the negative signal or switching from the negative signal to the positive signal along the signal transmitting direction of scanning line. The two adjacent pixel filters of the plurality of pixel filters corresponding to the plurality of pixel circuit units of the data line circuit adjacent to the data line circuit with the dark line are two pixel filters among the first pixel filter, the second pixel filter and the third pixel filter, with two different colors.

Further, the two adjacent pixel filters of the plurality of pixel filters corresponding to the plurality of pixel circuit units of the data line circuit adjacent to the data line circuit with the dark line may also be two pixel filters among the first pixel filter, the second pixel filter and the third pixel filter, with two different colors.

The pixel layer and the display panel of the embodiment of the present application utilize the design that the adjacent pixels in the pixel layer at the first direction have different colors and that the pixel filters corresponding to adjacent pixel circuit units in data line circuit have different color, especially for the pixel layer at the first direction with the dark line or data line circuit and its adjacent pixel layer at the first direction or data line circuit, and thereby the visual defect of vertical bright lines and vertical dark lines caused by dual rate driving design can be eliminated.

The description above is only a brief introduction to the technical solution of the present application. For a more clear understanding of the technical solutions of the present application, it is possible to carry out in accordance with the description of the disclosure; and for an easier understanding of the foregoing and other objectives, characteristics and advantages of the present application, preferred embodiments will be given hereinafter together with drawings, and the detailed descriptions are as follows.

### BRIEF DESCRIPTION OF THE DRAWINGS

The drawings are used to facilitate a further understanding of the embodiments of the present application, which constitute a part of the description; the drawings are used to exemplify the embodiments of the present application and explain the principle of the present application together with descriptions Obviously, the drawings below are only some examples of the present application, and the ordinary artisans concerned may obtain other drawings on the basis of these drawings without making creative efforts. In the drawings:

FIG. 1 is a schematic diagram of the display panel according to the present application.

FIG. 2A is a schematic diagram of the data signal formed by data line.

FIG. 2B is a schematic diagram of the superposition of the scanning signal and the data signal according to a first embodiment.

FIG. 2C is a schematic diagram of the superposition of the scanning signal and the data signal according to a second embodiment.

FIG. 2D is a schematic diagram of the superposition of the scanning signal and the data signal according to a third embodiment.

FIG. 3 is a schematic diagram of the pixel layers according to the present application.

FIG. 4A is a schematic diagram of the color filters according to the present application.

FIG. 4B is a schematic diagram of the dual rate driving circuit layer according to the present application.

### DETAILED DESCRIPTION OF THE EMBODIMENTS

The detailed structure and functions disclosed herein are only representative, to describe the exemplary embodiments of the present application. However, the present application may be realized by many alternative forms and shall not be limited to the embodiments described herein.

In the description of the present application, it should be understood that the direction or position relationship indicated by the terms ‘center’, ‘transverse’, ‘up’, ‘down’, ‘left’, ‘right’, ‘upright’, ‘horizontal’, ‘top’, ‘bottom’, ‘inside’, ‘outside’ etc. is based on drawings, just to facilitate and simplify the description of the present application rather than indicating or implying that the device or assembly must have specific direction or be structured or operated in specific direction, so it shall not be regarded as a limitation on the present application. Further, the terms ‘first’, ‘second’ are used only for description and shall not be interpreted as an indication or implication of relative importance or an implicit indication of the number of technical features. Thus, the feature defined by ‘first’, ‘second’ can explicitly or implicitly include one or more characteristics. In the present application, unless otherwise stated, the meaning of ‘a plurality of’ is two or more. Further, the term ‘comprise’ and its variations aim to cover something and not exclude others.

In the description of the present application, it should be explained that unless otherwise stated or defined, the terms ‘install’, ‘interconnect’ and ‘connect’ should be understood from a broad extent. For instance, it may be connected in a fixed, removable or integrated manner; and it may be mechanically or electrically connected; and it may be directly or indirectly (via a media in between) connected; and it may be the inside of two assemblies in communication with each other. The artisans concerned can understand the concrete meaning of the term in the present application according to specific circumstance.

The terms used here is only used to describe a specific embodiment rather than limiting the exemplary embodiments. Unless otherwise stated explicitly, the single form ‘one’ and ‘a’ aim to include plural form. It should also be understand that the term ‘include’ and/or ‘comprise’ defines the existence of the stated characteristics, integers, steps, operations, units and/or assemblies, and does not exclude the existence of one or more additional characteristics, integers, steps, operations, units and/or assemblies and/or their combination.

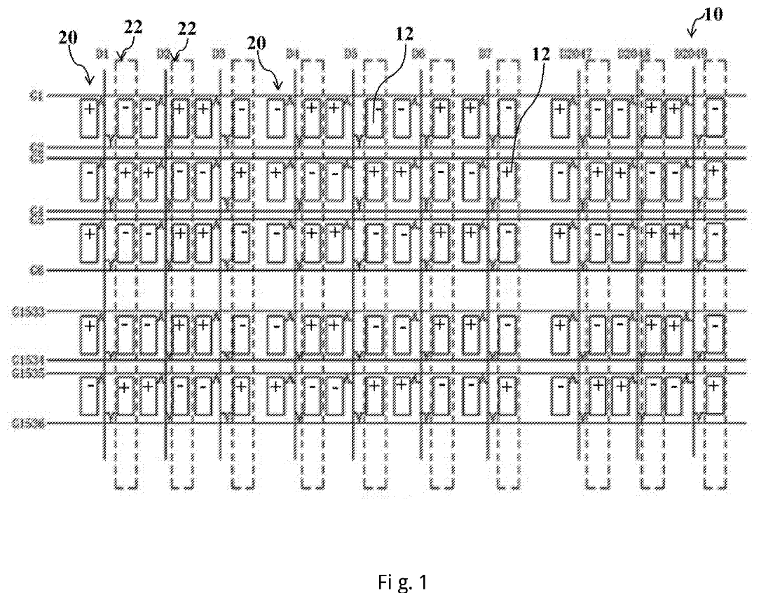

Please refer to FIG. 1 which is a schematic diagram of a display panel 10 of the present application. The figure shows a display panel 10 of double rate driving by taking 1+2 line driving pattern as an example, and this embodiment has 2049 data lines arranged vertically in first direction and 1536 scanning lines arranged transversely in second direction; the data lines are respectively illustrated by D1, D2 to D2049, and the scanning lines are respectively illustrated by G1, G2 to G1536. The signal transmitting direction of the scanning lines is from left to right.

The area where the data lines and the scanning lines are arranged in a staggered manner has basic unit 12 for displaying image, and while operation, each unit 12 has voltage signals, some of which are positive signal expressed by ‘+’ while others are negative signal expressed by ‘−’. The plurality of units 12 arranged column by column in parallel along the direction of data line can be called vertical unit column 20, and the units 12 in the whole display panel 10 are arranged in matrix.

Relatively dark defects will appear at the units 12 switching from the positive signal + to the negative signal − or switching from the negative signal − to the positive signal +; these units 12 are usually located at the same vertical unit column 20, hence the name ‘dark line column 22’.

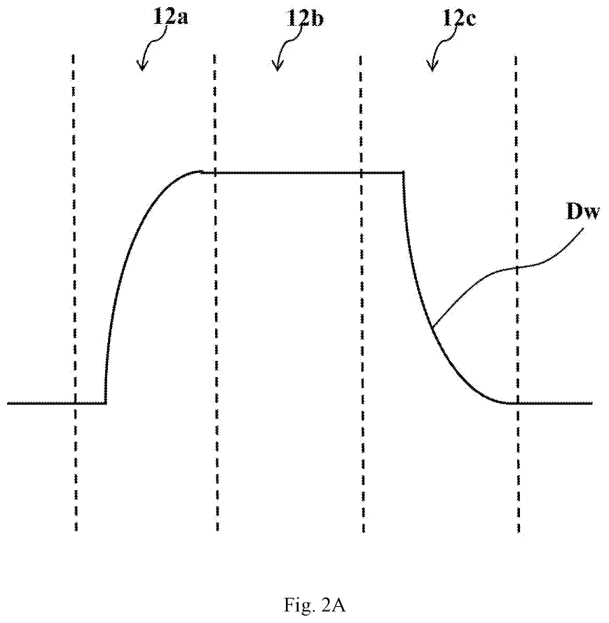

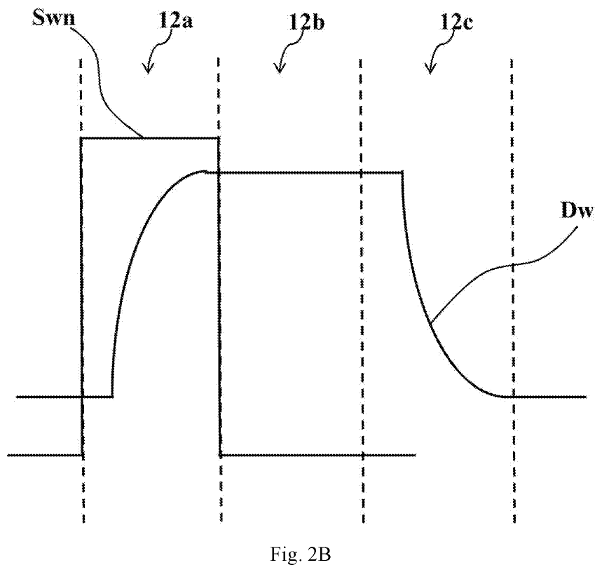

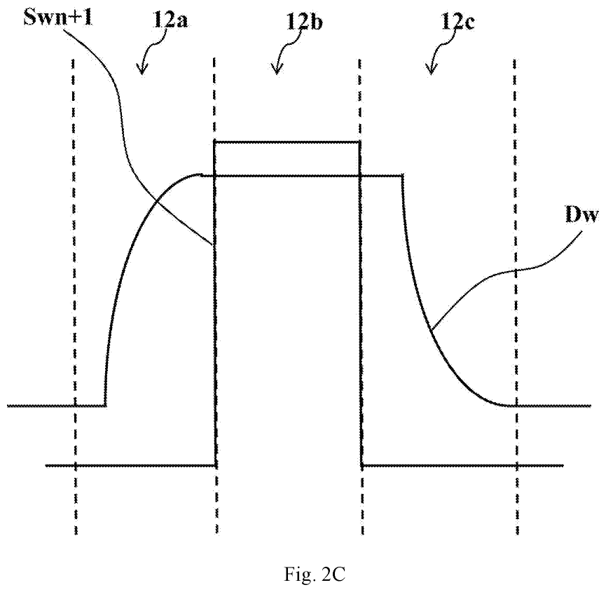

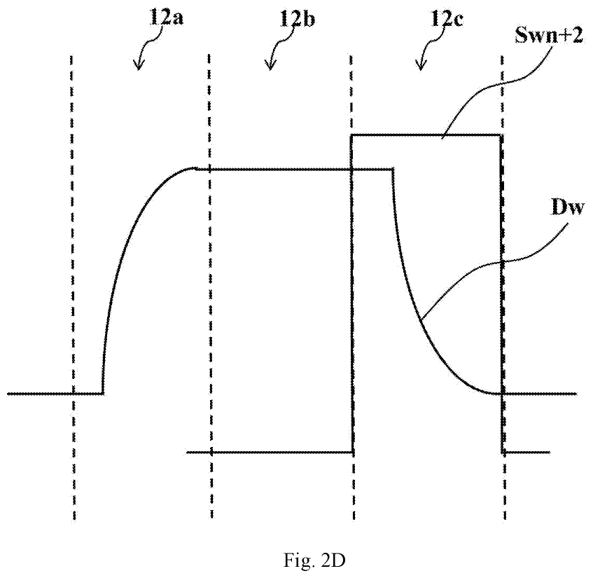

Please further refer to FIG. 2A, FIG. 2B, FIG. 2C and FIG. 2D along with FIG. 1. FIG. 2A is a schematic diagram of the data signal formed by data line. FIG. 2B is a schematic diagram of the superposition of scan signal and data signal of the first type. FIG. 2C is a schematic diagram of the superposition of scan signal and data signal of the second type. FIG. 2D is a schematic diagram of the superposition of scan signal and data signal of the third type. The reason why the charge waveform of display panel 10 causes dark line can be further explained by FIG. 2A, FIG. 2B, FIG. 2C and FIG. 2D.

The charge waveform Dw formed by the data signal from data line is shown by FIG. 2A. According to FIG. 1, the unit 12 switching from the negative signal − to the positive signal + corresponds to the unit block 12a; the unit 12 switching from the positive signal + to the positive signal + corresponds to the unit block 12b; the unit 12 switching from the positive signal + to the negative signal − corresponds to the unit block 12c.

Refer to FIG. 2B. When the scanning line of no.N inputs scanning signal, its charge waveform Swn, as shown in FIG. 2B, will be superposed on the charge waveform Dw formed by the data signal from data line, as a result of which dark lines will be formed, and this area is the unit block 12a switching from the negative signal − to the positive signal +.

Refer to FIG. 2C. When the scanning line of no.N+1 inputs scanning signal, its charge waveform Swn+1, as shown in FIG. 2C, will be superposed on the charge waveform Dw formed by the data signal from data line, as a result of which the obtained signal is more satisfactory than that of FIG. 2B and is normal bright line, and this area is the unit block 12b switching from the positive signal + to the positive signal +.

Refer to FIG. 2D. When the scanning line of no.N+2 inputs scanning signal, its charge waveform Swn+2, as shown in FIG. 2D, will be superposed on the charge waveform Dw formed by the data signal from data line, as a result of which dark lines are formed again, and this area is the unit block 12c switching from the positive signal + to the negative signal −.

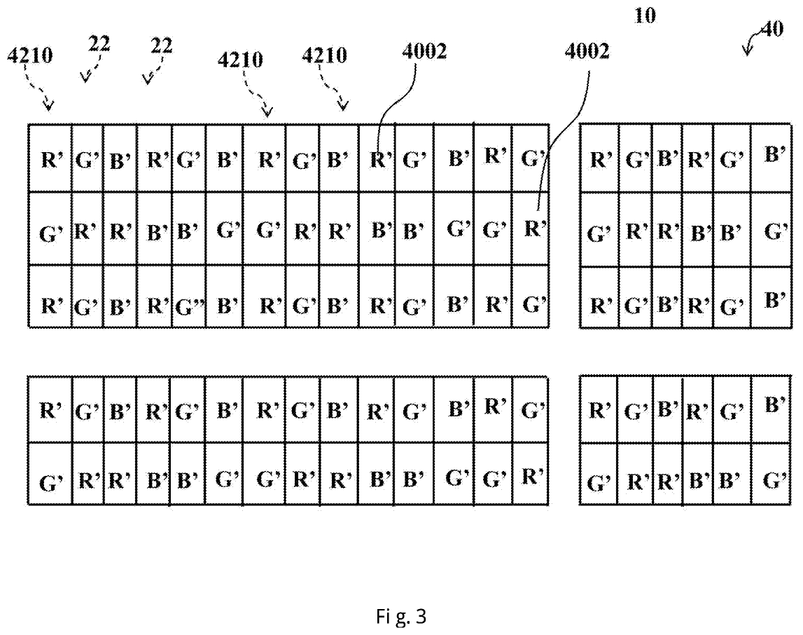

To solve the problem of dark lines, please refer to FIG. 3 which is a schematic diagram of the pixel layer 30 of the present application. This embodiment concerns a pixel layer 30 used for a display panel 10 comprising a plurality of pixels 3002. According to color, each pixel 3002 has one color from the colors of a first pixel R, a second pixels B or a third pixel G; for instance, the first pixel R may be a red pixel 3002, and the second pixels B may be a blue pixel 3002, and the third pixel G may be a green pixel 3002. The pixel layer 30 includes a plurality of pixel layers at the first directions 3010 and a plurality of second direction pixel layers 3020.

The plurality of pixel layer at the first directions 3010 may be arranged vertically; the pixel layer at the first direction 3010 includes a plurality of pixels 3002 which are a part of the plurality of pixels 3002 of the display panel 10; In particular, the plurality of pixel layer at the first direction 3010 may correspond to the vertical unit column 20 in FIG. 1. The two adjacent pixels 3002 are two pixels 3002 among the first pixel R, the second pixels B and the third pixel Q with two different colors. In other words, in a pixel layer at the first direction 3010, any two adjacent pixels 3002 have different color.

The plurality of second direction pixel layers 3020 may be arranged transversely; the second direction pixel layer 3020 includes a plurality of pixels 3002 which are also a part of the plurality of pixels 3002 of the display panel 10; The plurality of pixels 3002 in the second direction pixel layer 3020 includes the first pixel R, the second pixels B and the third pixel G; In other words, whether the adjacent pixels in the second direction pixel layer 3020 have the same color or not, a whole line of the second direction pixel layer 3020 includes the first pixel R, the second pixels B and the third pixel Q with three colors.

Particularly, the plurality of pixel layer at the first directions 3010 comprise a pixel layer at the first direction with the dark line and a pixel layer at the first direction of bright line; and while displaying the same gray-scale brightness, the display brightness of the pixel layer at the first direction with the bright line is larger than that of the pixel layer at the first direction with the dark line, and the pixel layer at the first direction with the bright line is close and parallel to the pixel layer at the first direction with the dark line; the pixel layer at the first direction 3010 of dark line corresponds to the dark line column 22 in FIG. 1. The pixel layer at the first direction 3010 is driven by a data line (D1 to D2049) extending vertically; and the pixels in the pixel layer at the first direction 3010 have one kind of signal from positive signal + and negative signal −; and the pixel layer at the first direction 3010 of dark line is the pixel layer at the first direction 3010 switching from the positive signal + to the negative signal − or switching from the negative signal − to the positive signal + along the signal transmitting direction of scanning line. As shown by FIG. 1, the scanning lines are G1 to G1536, and the signal is transmitted from left to right.

In an embodiment, especially the two adjacent pixels 3002 of the plurality of pixels 3002 of the pixel layer at the first direction 3010 which is bright line and adjacent to the pixel layer at the first direction 3010 of dark line are two pixels 3002 among the first pixel R, the second pixels B and the third pixel Q with two different colors. In other words, the adjacent pixels 3002 in the pixel layer at the first direction 3010 of bright line are of different color.

In prior art, the pixel layer at the first direction 3010 includes pixels 3002 with same color, so when vertical lines meet bright lines and dark lines, it will be easily recognized by eyes; As shown by FIG. 3, in an embodiment, the color of the pixels 3002 of the even number line in the adjacent pixel layer at the first direction 3010 are exchanged, so for dark lines and bright lines, the whole column will not be the pixels 3002 of same color, but the pixels 3002 with two different colors, so even if dark lines appear, our eyes will still feel soft and smooth because of the balance and harmony of the color of bright lines.

Further, to obtain a softer visual effect and facilitate the manufacture in the process, the two adjacent pixels 3002 of the plurality of pixels 3002 of the pixel layer at the first direction 3010 of dark line may also be two pixels 3002 among the first pixel R, the second pixels B and the third pixel Q with two different colors.

Further, refer to FIG. 3, the present application may also be the embodiment of the pixel layer 30; the present application concerns a pixel layer 30 used for a display panel 10 comprising a plurality of pixels 3002. According to color, each pixel 3002 has one color from the colors of a first pixel R, a second pixels B or a third pixel G; The pixel layer 30 includes a plurality of pixel layers at the first directions 3010.

The plurality of pixel layer at the first directions 3010 are arranged vertically in parallel; each pixel layer at the first direction 3010 includes a plurality of pixels 3002 which are a part of the plurality of pixels 3002; a part of the plurality of the pixel layer at the first direction 3010 is the pixel layer at the first direction 3010 of dark line. The two adjacent pixels 3002 of the plurality of pixels 3002 of the pixel layer at the first direction 3010 which is bright line and adjacent to the pixel layer at the first direction 3010 of dark line are two pixels 3002 among the first pixel R, the second pixels B and the third pixel Q with two different colors.

The pixel layer at the first direction 3010 is driven by a data line arranged vertically; and the pixels in the pixel layer at the first direction 3010 have one kind of signal from positive signal + and negative signal −; and the pixel layer at the first direction 3010 of dark line is the pixel layer at the first direction 3010 switching from the positive signal + to the negative signal − or switching from the negative signal − to the positive signal + along the signal transmitting direction of scanning line.

Further, to obtain a softer visual effect and facilitate the manufacture in the process, the two adjacent pixels 3002 of the plurality of pixels 3002 of the pixel layer at the first direction 3010 of dark line may also be two pixels 3002 among the first pixel R, the second pixels B and the third pixel Q with two different colors.

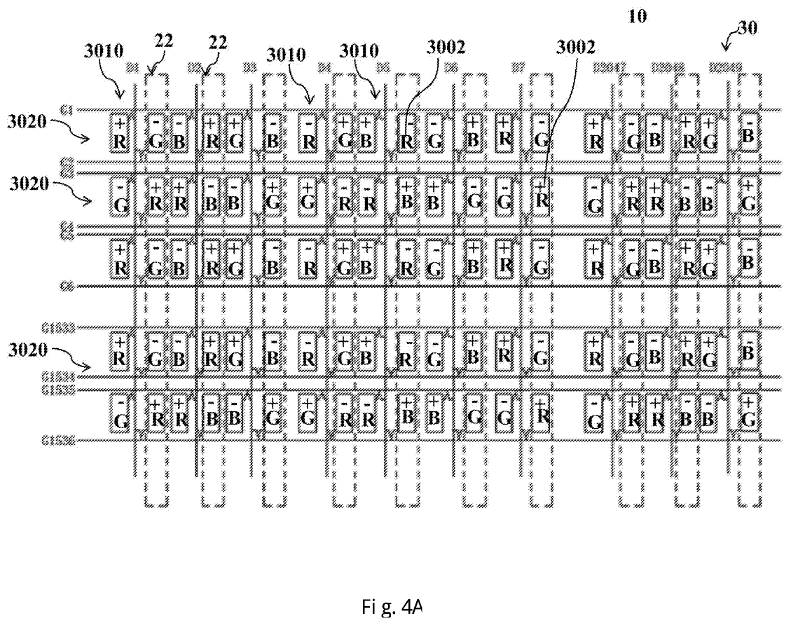

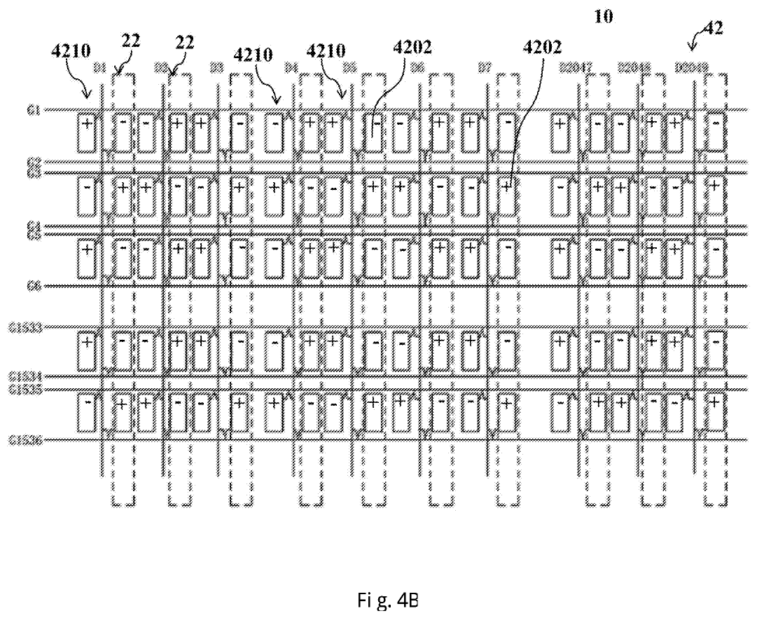

Please refer to FIG. 4A and FIG. 4B; FIG. 4A is a schematic diagram of the color filter 40 of the present application; FIG. 4B is a schematic diagram of the dual rate driving circuit layer 42 of the present application. This embodiment is another embodiment, and concerns a display panel 10 comprising a color filter 40 and a dual rate driving circuit layer 42.

The color filter 40 includes a plurality of pixel filters 4002 arranged in matrix, each pixel filter 4002 having its color from one of the colors of a first pixel filter R′, a second pixel filter B′ and a third pixel filter G′.

The dual rate driving circuit layer 42 is arranged in parallel with the color filter 40, and along the vertically-extending direction of data line (D1 to D2049) are a plurality of data line circuits 4210 arranged vertically; each data line circuit 4210 includes a plurality of pixel circuit units 4202 corresponding to the plurality of pixel filters 4002 and also arranged in matrix; In particular, the plurality of data line circuits 4210 may correspond to the vertical unit column 20 in FIG. 1.

The two adjacent pixel filters 4002 of the plurality of pixel filters 4002 corresponding to the plurality of pixel circuit units 4202 in the data line circuit 4210 are two pixel filters 4002 among the first pixel filter R′, the second pixel filter B′ and the third pixel filter G′, with two different colors.

Like the above-mentioned display panel 10, A part of the plurality of data line circuits 4210 are data line circuit 4210 of dark line; the data line circuit 4210 of dark line may correspond to the dark line column 22 in FIG. 1.

The pixel circuit unit 4202 in the data line circuit 4210 has one kind of signal of positive signal + and negative signal −; and the data line circuit 4210 of dark line is a data line circuit 4210 switching from the positive signal + to the negative signal − or switching from the negative signal − to the positive signal + along the signal transmitting direction of scanning line.

The two adjacent pixel filters 4002 of the plurality of pixel filters 4002 corresponding to the plurality of pixel circuit units 4202 of the data line circuit 4210 adjacent to the data line circuit 4210 of dark line are two pixel filters 4002 among the first pixel filter R′, the second pixel filter B′ and the third pixel filter G′, with two different colors.

Further, to obtain a softer visual effect and facilitate the manufacture in the process, the two adjacent pixel filters 4002 in the plurality of pixel filters 4002 corresponding to the plurality of pixel circuit units 4202 of the data line circuit 4210 adjacent to the data line circuit 4210 of dark line are two pixel filters 4002 among the first pixel filter R′, the second pixel filter B′ and the third pixel filter G′, with two different colors.

To sum up, the pixel layer and the display panel 10 of the embodiment of the present application utilize the design that the adjacent pixels 3002 in the pixel layer at the first direction 3010 have different colors or that the pixel filters 4002 corresponding to adjacent pixel circuit units 4202 in data line circuit 4210 have different color, especially for the pixel layer at the first direction 3010 of dark line or data line circuit 4210 and its adjacent pixel layer at the first direction 3010 or data line circuit 4210, and thereby the visual defect of vertical bright lines and vertical dark lines caused by dual rate driving design can be eliminated.

The description above is only a preferred embodiment of the present application and shall not be regarded as a limitation on the present application; the present application has disclosed preferred embodiments which are not to limit the present application; some changes and equivalent modifications can be made by the artisans concerned without departing from the scope or spirit of the disclosure; and the changes and modifications made on the basis of technical spirits of the present application without departing from the scope or spirit of the disclosure will still fall within the scope of the present application.

What is claimed is:

1. A pixel layer structure for a display panel, comprising a plurality of pixels, each of the pixels respectively belonging to one of first pixels, second pixels or third pixels based on a color of each pixel, wherein the pixel structure comprises:
at least one of pixel layer in a first direction, the pixel layer in the first direction comprising a plurality of pixels, any two adjacent of the pixels having a different color with each other among the first pixels, the second pixels and the third pixels; and
at least one of pixel layer in a second direction, the pixel layer in the second direction comprising a plurality of pixels comprising the first pixels, the second pixels and the third pixels.

2. The pixel layer structure according to claim 1, wherein the at least one of pixel layer at the first direction is a plurality of pixel layers at the first direction, the plurality of pixel layers at the first direction comprising a pixel layer at the first direction with a dark line and a pixel layer at the first direction with a bright line; and while displaying a same gray-scale brightness, a display brightness of the pixel layer at the first direction with the bright line is larger than that of the pixel layer at the first direction with the dark line; and the pixel layer at the first direction with the bright line is adjacent and parallel to the pixel layer at the first direction with the dark line; wherein the two adjacent pixels of the plurality of pixels in the pixel layer at the first direction with the bright line are two pixels with two different colors among the first pixels, the second pixels and the third pixels.

3. The pixel layer structure according to claim 2, wherein the pixel layers at the first direction is driven by a data line extending in the first direction; and the pixels in the pixel layers at the first direction have one of positive signal and negative signal; and the pixel layer at the first direction with the dark line is the pixel layer at the first direction along a signal transmitting direction of a scanning line, wherein a signal of the scanning line switches from positive to negative or from negative to positive signal transmitting direction.

4. The pixel layer structure according to claim 2, wherein the two adjacent pixels of the plurality of pixels in the pixel layer at the first direction with the dark line are two pixels with two different colors among the first pixels, the second pixels and the third pixels.

5. The pixel layer structure according to claim 2, wherein the plurality of pixels in each of the pixel layers at the first direction with the dark line, comprise the pixels with two different colors alone.

6. The pixel layer structure according to claim 2, wherein the plurality of pixels in each of the pixel layers at the first direction with the bright line comprise the pixels with two different colors alone.

7. The pixel layer structure according to claim 1, wherein the plurality of pixels in each of the pixel layers at the first direction comprise two pixels with two different colors alone.

8. A pixel layer structure for a display panel, comprising a plurality of pixels, each of the pixels respectively belonging to one of first pixels, second pixels or third pixels based on a color of each pixel, wherein the pixel layer structure comprises:
a plurality of pixel layers at the first direction arranged in parallel along the first direction, each of the pixel layers at the first direction comprising a part of the plurality of pixels; and the plurality of pixel layer at the first direction the plurality of pixel layers at the first direction comprising a pixel layer at the first direction with a dark line and a pixel layer at the first direction with a bright line; and while displaying a same gray-scale brightness, a display brightness of the pixel layer at the first direction with the bright line is larger than that of the pixel layer at the first direction with the dark line; and the pixel layer at the first direction with the bright line is adjacent and parallel to the pixel layer at the first direction with the dark line; wherein the two adjacent pixels of the plurality of pixels in the pixel layer at the first direction with the bright line are two pixels with two different colors among the first pixels, the second pixels and the third pixels.

9. The pixel layer according to claim 8, wherein the pixel layers at the first direction is driven by a data line extending in the first direction; and the pixels in the pixel layers at the first direction have one of positive signal and negative signal; and the pixel layer at the first direction with the dark line is the pixel layer at the first direction along a signal transmitting direction of a scanning line, wherein a signal of the scanning line switches from positive to negative or from negative to positive signal transmitting direction

10. The pixel layer according to claim 8, wherein the two adjacent pixels of the plurality of pixels in the pixel layer at the first direction with the dark line are two pixels with two different colors among the first pixels, the second pixels and the third pixels.

11. The pixel layer according to claim 8, wherein the plurality of pixels in each of the pixel layers at the first direction with the dark line, comprise the pixels with two different colors alone.

12. The pixel layer according to claim 8, wherein the plurality of pixels in each of the pixel layers at the first direction with the bright line comprise the pixels with two different colors alone.

13. A display panel comprising:
a plurality of data lines extending along a first direction;
a plurality of scanning lines respectively extending along a second direction;
a color filter, comprising a plurality of pixel filters arranged in a matrix, each of the pixel filter is selected from a first pixel filter, a second pixel filter and a third pixel filter based on a color of each pixel filter; and
a dual rate driving circuit layer, arranged in parallel with the color filter, and the dual rate driving circuit layer comprising a plurality of data line circuits extending along the first direction, each of the data line circuits comprising a plurality of pixel circuit units arranged in matrix corresponding to the plurality of pixel filters;
wherein the two adjacent pixel filters of the plurality of pixel filters corresponding to the plurality of pixel circuit units of the data line circuits, are two pixel filters with two different colors among the first pixel filter, the second pixel filter and the third pixel filter.

14. The display panel according to claim 13, wherein a part of the plurality of data line circuits is a data line circuit with a dark line; and the pixel circuit unit in the data line circuit has a positive signal or a negative signal; and the data line circuit with the dark line is a data line circuit along a signal transmitting direction of a scanning line, switching from a positive signal to a negative signal or from the negative signal to the positive signal transmitting direction; wherein the two adjacent pixel filters of the plurality of pixel filters corresponding to the plurality of pixel circuit units of the data line circuit adjacent to the data line circuit with the dark line, are two pixel filters with two different colors among the first pixel filter, the second pixel filter and the third pixel filter.

15. The display panel according to claim 14, wherein the two adjacent pixel filters of the plurality of pixel filters corresponding to the plurality of pixel circuit units of the data line circuit adjacent to the data line circuit with the dark line are two pixel filters with two different colors among the first pixel filter, the second pixel filter and the third pixel filter.

16. The display panel according to claim 15, wherein the plurality of pixel filters corresponding to the plurality of pixel circuit units of the data line circuit with the dark line, comprise two pixel filters with two different colors.

17. The display panel according to claim 14, wherein the plurality of pixel filters corresponding to the plurality of pixel circuit units of the data line circuit with the dark line, comprise two pixel filters with two different colors.

18. The display panel according to claim 13, wherein the plurality of pixel filters corresponding to the plurality of pixel circuit units of the data line circuit, comprise two pixel filters with two different colors.
